(19) United States
(12) Patent Application Publication
(10) Pub. No.: US 2007/0239762 A1
(43) Pub. Date: Oct. 11, 2007

(54) Automated interactive visual mapping utility and method for transformation and storage of XML data

(75) Inventor: Farzad Farahbod, El Cerrito, CA (US)

Correspondence Address: SANDRA M. PARKER;LAW OFFICE OF SANDRA M. PARKER, 329 LA JOLLA AVENUE, LONG BEACH, CA, 90803, US

(73) Assignee: International Business Machines Corporation, Armonk, NY (US)

(21) Appl. No.: 11/393,223

(22) Filed: Mar. 30, 2006

(51) Int. Cl. G06F 7/00; G06F 17/00; G06F 9/44

(52) U.S. Cl. 707/102; 707/100; 715/513; 715/523; 717/109

(57) ABSTRACT

A method, apparatus and computer program product is provided for automatic mapping of Extensible Markup Language (XML) data through an interactive visual mapping tool before storing the XML data into a target destination. The method uses an interactive visual mapping tool having a graphic user interface (GUI) to obtain automatic mapping of an XML source document or its fragment and the target destination. The GUI is menu-driven, displays the XML data in the native format and has several editors. Interactions with the GUI automatically generate an XML mapping definition document and a mapping code. The target destination can be one or more XML columns, a web service call, a standalone application call, a function's or stored procedure's input parameter of XML type and it may be located in a heterogeneous RDBMS environment. Before storage the XML data may be transformed with an Extensible Stylesheet Language Transformation which may be debugged.

### RELATED APPLICATION

The present invention is related to a co-pending U.S. patent application entitled “Automated Interactive Visual Mapping Utility For Validation and Storage of XML Data”, filed concurrently, Ser No. ______, (attorney docket no. SVL920050150US1), assigned to the assignee of the present invention and fully incorporated herein by reference.

### BACKGROUND OF THE INVENTION

1. Field of the Invention

The present invention generally relates to database management systems, and, more particularly, to an automated interactive visual mapping utility and method for transformation and storage of Extensible Markup Language (XML) data within computer-based database management systems.

2. Description of Related Art

The increasing popularity of electronic commerce has prompted many companies to turn to application servers to deploy and manage their applications effectively. Quite commonly, these application servers are configured to interface with a database management system (DBMS) for storage and retrieval of data. This often means that new applications must work with distributed data environments. As a result, application developers frequently find that they have little or no control over which DBMS product is to be used to support their applications or how the database is to be designed. In many cases, developers find out that data critical to their application is spread across multiple DBMSes developed by different software vendors.

A repository, such as a relational database, provides an environment to securely store and share XML documents and XML schemas. Authorized users of a repository have secure access to important XML documents and XML schemas at any time and from anywhere. By using a repository system, that can contain one or more relational database systems, users can locate and retrieve the latest version of XML documents and XML schema documents.

The standard approach for storing XML documents in a relational database has been through customized specific third-party software, such as programs, database command line arguments or code-based applications. A software program reads an XML document and appropriate XML schema(s), performs proper transformation and validation of the XML document contents and then stores the transformed and validated XML document in one or more database tables. While this software program facilitates the data transformation, validation and storage process, someone has to develop its code. Presently, there is no single generic intuitive solution through which all or some portions of XML documents can be transformed and stored quickly during updates or inserts of XML data into target destinations, such as columns of database tables.

Therefore, there is a need to provide a method and a system that can be used in an easy, efficient and intuitive way for transformation of XML data during updates or inserts into a target destination, where the target destination of the transformed XML data may be one or more XML columns residing in one or more databases of a heterogeneous Relational DataBase Management System (RDBMS) environment.

### SUMMARY OF THE INVENTION

The foregoing and other objects, features, and advantages of the present invention will be apparent from the following detailed description of the preferred embodiments which makes reference to several drawing figures.

One preferred embodiment of the present invention is a method for automatic mapping of Extensible Markup Language (XML) data through an interactive visual mapping tool before storing the XML data into a target destination. The method uses an interactive visual mapping tool having a graphic user interface (GUI) to obtain automatic mapping of an XML source document or its fragment and the target destination. The GUI is menu-driven, displays the XML data in the native format and has several editors. Interactions with the GUI automatically generate an XML mapping definition document and a mapping code. The target destination can be one or more XML columns, a web service call, a standalone application call, a function's or stored procedure's input parameter of XML type and it may be located in a heterogeneous RDBMS environment. Before storage the XML data may be transformed with an Extensible Stylesheet Language Transformation (XSLT) which may be debugged.

Another preferred embodiment of the present invention is a system implementing the above-mentioned method embodiment of the present invention.

Yet another preferred embodiment of the present invention includes a computer program product tangibly embodying a program of instructions executable by the computer to perform method steps of the above-mentioned method embodiment of the present invention.

### BRIEF DESCRIPTION OF THE DRAWINGS

Referring now to the drawings in which like reference numbers represent corresponding parts throughout:

FIG. 1 illustrates a block diagram of an exemplary computer hardware and software environment, according to the preferred embodiments of the present invention;

FIG. 2 illustrates a flowchart of an exemplary method for automatic XML data transformation, according to the preferred embodiments of the present invention;

FIG. 3 illustrates an exemplary XML source document with a fragment selected for mapping, according to the preferred embodiments of the present invention;

FIGS. 4A and 4B illustrate the structure of an exemplary XSLT code and transformed XML data, according to the preferred embodiments of the present invention;

FIGS. 5A and 5B illustrate the structure of exemplary XML Column Mapping Definition document code excerpts, according to the preferred embodiments of the present invention;

FIG. 6 illustrates how a target destination connection to a database table column is formed, according to the preferred table column mapping embodiments of the present invention;

FIG. 7 illustrates the structure of an Add Connection dialog box, according to the preferred table column mapping embodiments of the present invention;

FIG. 8 illustrates how database objects are displayed in a tree under the connection, according to the preferred table column mapping embodiments of the present invention;

FIG. 9 illustrates a menu for selection of the Show Data entry, according to the preferred table column mapping embodiments of the present invention;

FIG. 10 illustrates a drop-down list for an XML data column, with three possible XML editors, according to the preferred table column mapping embodiments of the present invention;

FIGS. 11-13 illustrate an XML Text Visualizer window, according to the preferred table column mapping embodiments of the present invention;

FIG. 14 illustrates an HTL Visualizer window, according to the preferred table column mapping embodiments of the present invention;

FIGS. 15-18 illustrate an XML Designer window with XSLT and Fragments columns, according to the preferred table column mapping embodiments of the present invention;

FIGS. 19-24 correspond to FIGS. 6-18 but here the target destination is a stored procedure's input parameter, according to the preferred stored procedure mapping embodiments of the present invention; and

FIGS. 25-26 illustrate debugging, according to the preferred mapping embodiments of the present invention.

### DETAILED DESCRIPTION OF THE PREFERRED EMBODIMENTS

In the following description of the preferred embodiments reference is made to the accompanying drawings which form the part thereof, and in which are shown by way of illustration specific embodiments in which the invention may be practiced. It is to be understood that other embodiments may be utilized, and structural and functional changes may be made without departing from the scope of the present invention.

The present invention is directed to a system, method and computer program product embodying a program of instructions executable by a computer to perform the method of the present invention for automatic interactive visual mapping, and possibly transformation, of Extensible Markup Language (XML) data during storage of the XML data into a target destination. It is implemented in a user interactive mapping utility which can be used in an easy, efficient and intuitive way to perform automated interactive mapping, and possibly transformation, during user's interactions with a visual graphic user interface (GUI) of the present invention.

The method allows a user to interact with the GUI to obtain mapping of an XML source document or its fragment and the target destination and to automatically obtain XML data transformations. The GUI is menu-driven and displays the XML data in the native format with a selection of the XML transformation codes. Interactions with the GUI automatically generate an XML column mapping definition document and a transformation code.

The interactive mapping utility of the present invention is used for automatic interactive visual dynamic mapping of one or more XML documents or XML document fragments accomplished through an interactive visual dynamic mapping process. An XML document can be dissected into fragments, based on user's selection of target destinations, and an appropriate XML transformation code may be used for each fragment during the transformation process. Transformed XML documents or XML document fragments are stored after transformation in target destinations. The target destination of the XML data may be any database object declared as XML format type, such as one or more XML columns, a web service call, a standalone application call, a function's or stored procedure's input parameter of XML type, etc. Target destinations of the XML data may reside in one or more databases of a heterogeneous Relational DataBase Management System (RDBMS) environment. Thus, the interactive mapping utility provides the means to apply transformation code to XML data prior to reaching their final target destination, such as a database, thus optimizing data storage utilization and system efficiency.

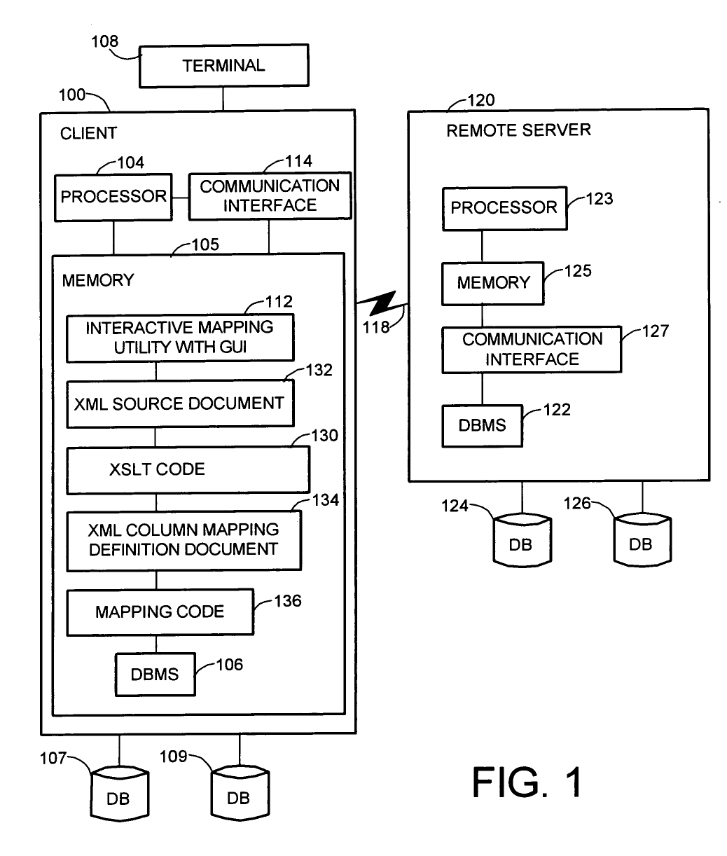

FIG. 1 illustrates an exemplary computer hardware and software environment usable by the preferred embodiments of the present invention to enable the automatic data mapping method of the present invention. FIG. 1 includes a client 100 having a client terminal 108 and one or more conventional processors 104 executing instructions stored in an associated computer memory 105. The memory 105 can be loaded with instructions received through an optional data storage drive or through an interface with a computer network. Client 100 further includes a user interactive mapping utility 112 of the present invention with a graphical user interface (GUI) accessed from the terminal 108 for interactions with a user and preferably interfaced with a web browser. Client 100 may use at least one standard Structured Query Language (SQL), XML or Web communication interface 114 connecting the client 100 to one or more optional remote servers 120 via a network communication line 118, to obtain access to databases of single or multiple data sources, such as a database server DataBase Management System (DBMS) 122, and data storage devices 124, 126, each of which may be a DB2® or non-DB2 source, may reside on different systems and may store data in different formats. Optional remote server 120 has its own processor 123, communication interface 127 and memory 125.

Processor 104 on the client side may be connected to one or more DBMSes 106 and electronic data storage devices 107, 109, such as disk drives, that store one or more databases. The data storage devices 107, 109, 124, 126 may include, for example, optical disk drives, magnetic tapes and/or semiconductor memory. Each storage device permits receipt of a program storage device, such as a magnetic media diskette, magnetic tape, optical disk, semiconductor memory and other machine-readable storage device, and allows for method program steps recorded on the program storage device to be read and transferred into the computer memory. The recorded program instructions may include the code for the method embodiments of the present invention. Alternatively, the program steps can be received into the operating memory 105 from a computer over the network.

Operators of the client terminal 108 use a standard operator terminal interface (not shown) with a data input and selection device, such as a keyboard, touch screen, track ball, mouse, etc., to transmit electrical signals to and from the client 100 that represent commands for performing various tasks, such as search and retrieval functions and queries, against the database stored on the electronic data storage device 107, 109, 124, 126. In the present invention, these queries conform to the Structured Query Language (SQL) standard, and invoke functions performed by DBMS 106, 122, such as a Relational DataBase Management System (RDBMS) software. In the preferred embodiments of the present invention, the RDBMS software is the DB2® product, offered by IBM® for the AS400® or z/OS® operating systems, the Microsoft® Windows® operating systems, or any of the UNIX®-based operating systems supported by the DB2®. Those skilled in the art will recognize, however, that the present invention has application to any DBMS software that uses SQL, and may similarly be applied to non-SQL queries.

FIG. 1 further illustrates a software environment of the present invention which enables the preferred embodiments of the present invention. For that purpose the client 100 of the system shown in FIG. 1 includes the user interactive mapping utility 112 with the GUI, which incorporates preferred methods of the present invention for interactive dynamic mapping and, if requested, automatic transformation of XML data with an Extensible Stylesheet Language Transformation (XSLT) code 130. The XML data are stored in a target destination, such as database(s) of at least one data source, such as DBMS 106, and data storage devices 107, 109. In a network environment, the target destination can be database(s) of at least one remote data source, such as DBMS 122, and data storage devices 124, 126, when the XML data are transmitted across the network communication line 118. However, the present invention is not limited to a network environment and it is applicable to a simpler system where the XML data are stored in only one database of the data storage device 107 or 109 and there is no remote server 120.

Each data storage device 107, 109, 124, 126 may have one or more relational databases, each having a plurality of tables, and the client 100 and/or remote server 120 may host an RDBMS environment that is used for storage of XML data from XML source documents 132, and documents created during the mapping process, such as an XML Column Mapping Definition document 134 and a mapping code 136. Target destination for the XML document may be one or more XML columns of at least one database residing on data storage device 107 or 109 or in databases stored in multiple data storage devices 107, 109, 124, 126 and connected via network communication line 118. In some preferred aspects network communication line 118 can provide communication via wireless technology. In other preferred aspects the target destination may be an input or input/output parameter of a stored procedure. While the user interactive mapping utility 112 is running, XML source documents 132, XML Column Mapping Definition document 134 and mapping code 136 are located in memory 105, as shown in FIG. 1.

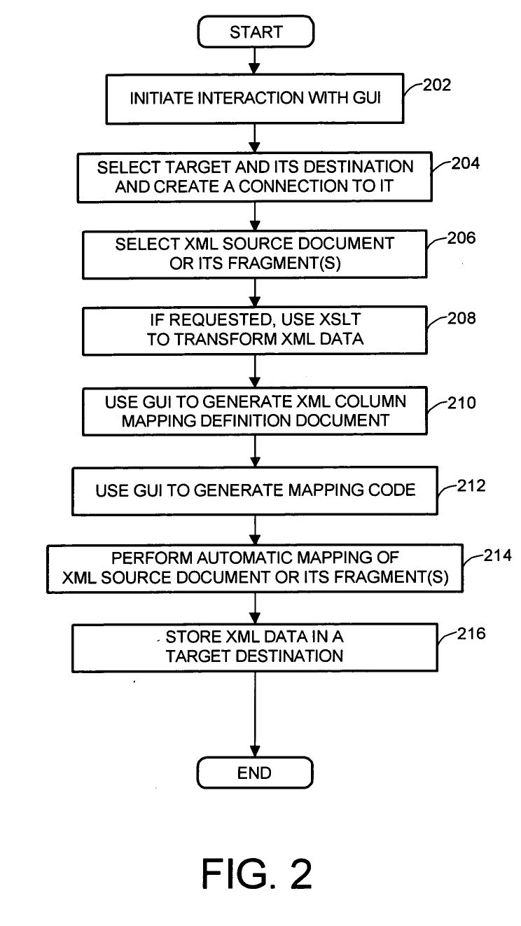

FIG. 2 illustrates a flowchart of an exemplary method that performs interactive dynamic mapping and possibly XML data transformation, according to the preferred embodiments of the present invention, implemented in the user interactive mapping utility 112 illustrated in FIG. 1. The preferred embodiments of the present invention perform mapping of XML data from the XML source document 132 into a target destination through a column mapping and code generation process wherein the code is applied to XML data prior to reaching their final, target destination, such as a database, selected during interactions with a user. The user interactive mapping utility 112 performs automatic mapping and possibly transformation of one or more XML source documents 132 or XML source document fragments through a dynamic mapping process.

According to the preferred method embodiment of the present invention, in step 202 of FIG. 2, a user initiates mapping of XML data from at least one XML source document 132 by initiating interaction with the GUI of the user interactive mapping utility 112 via terminal 108 input device. In step 204, the user selects a target destination, located in client 100 or remote server 120 system's data storage device 107, 109, 124, 126, and creates a connection to it. The target destination may be one or more database tables and their columns, previously declared as XML type columns, to receive all or a portion of each XML source document 132. The XML source documents are Extensible Markup Language (XML) documents, residing in a data storage device 107, 109, 124, 126 or entered via network prior to storage.

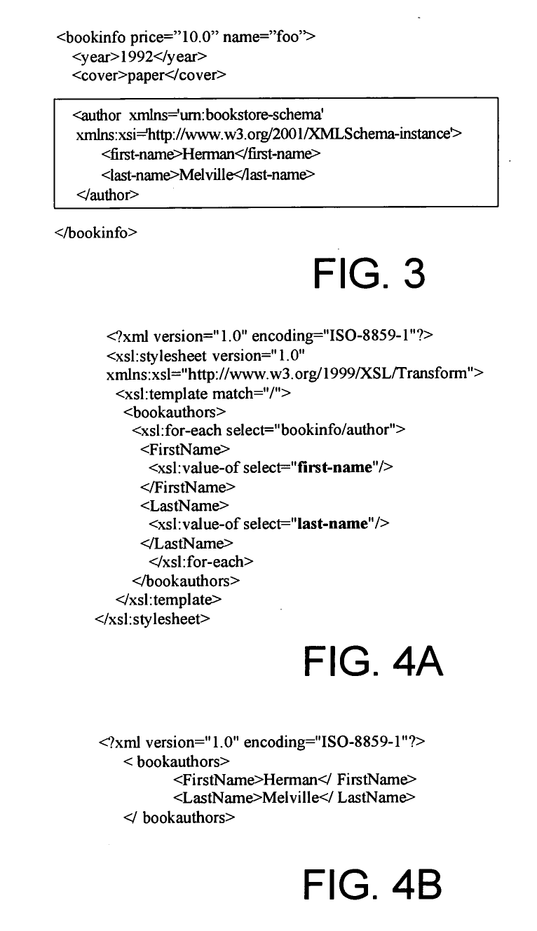

An example, shown in FIGS. 3-5, illustrates an exemplary XML source document with a fragment selected for mapping into a selected XML column target destination, named ‘bookinfo’, of a table named ‘book’, using the user interactive mapping utility 112 of the present invention, a generated XML column mapping definition document and a generated code which is in this case a SQL script for DB2®.

In step 206, the user selects an entire XML source document 132 or its fragments that require mapping. Each fragment block may be selected by using the GUI to draw a box around it. XPath code is generated automatically by the user interactive mapping utility 112 to identify the selected XML source document fragment block or the XML source document. In the XML document shown in FIG. 3, the box that the user draws creates an XML fragment named ‘author’, and the XPath to the box is named ‘bookinfo/author’.

Next, in step 208, the user may request that the user interactive mapping utility 112 performs a formatting or transformation of the selected XML data to another XML data format before reaching the selected target destination. User can select for mapping one or more XML transformation languages, known as Extensible Stylesheet Language Transformation (XSLT), to be applied to entire or selected area(s) of the source XML document. XSLT is designed for use as part of the Extensible Stylesheet Language (XSL) which is a stylesheet language for XML and defines a set of rules that changes the structure of an XML document into another data structure. The user interactive mapping utility 112 will create, in step 210, an XML Column Mapping Definition document which will include all this mapping information to be applied to transform the selected XML document or its fragments through each specified XSLT code 130 before reaching the target destination. FIG. 4A illustrates an XSLT code created by the present invention's GUI tool to be applied to the example of FIG. 3 on the XML column named ‘bookinfo’, in the table named ‘book’, to obtain the transformation of FIG. 4B.

The user selected transformation may be a formatting according to a standard, such as a date and time formatting or color coding, a transformation to a different RDBMS type for storage in another server of a heterogeneous system with multiple different RDBMSes, transformation of XML data to different XML data, transformation of XML data to HTML data, graphs, etc. FIG. 4A illustrated XSLT code that applies transformation on the ‘bookinfo/author’ author's name and assigns a tag name ‘bookauthors’ to the author's name, as shown in FIG. 4B.

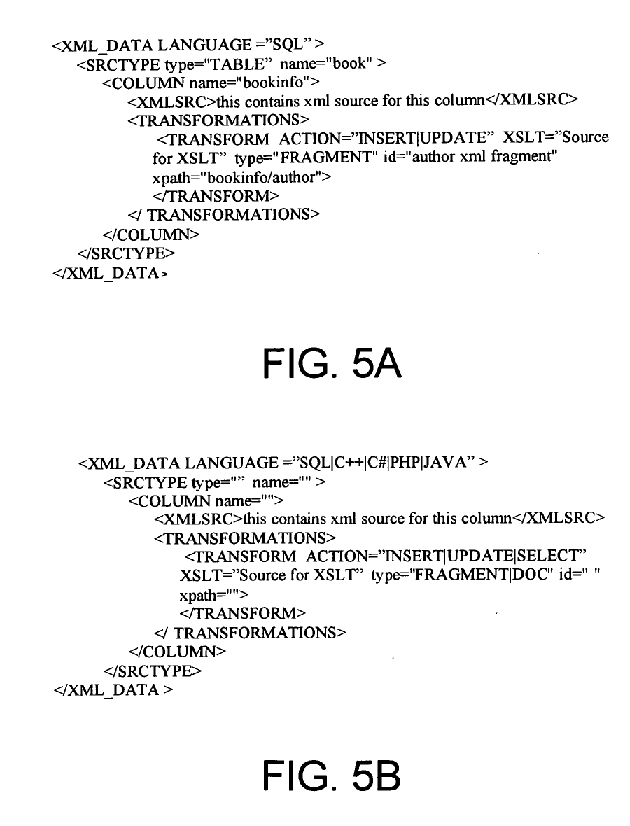

After the user finalizes all selections of steps 202-208, in step 210 the user interactive mapping utility 112 of the present invention automatically generates an XML Column Mapping Definition document 134, which can be saved in a file of the data storage device 107, 109, 124, 126, or may reside in memory 105 while the user interactive mapping utility 112 is running. An exemplary XML Column Mapping Definition document 134 code excerpt is shown in FIG. 5A.

The generated XML Column Mapping Definition document 134 contains all user mapping and transformation specifications. Based on the XML Column Mapping Definition document 134, in step 212 the user interactive mapping utility 112 automatically creates mapping code 136 used for automatic mapping of the XML source document 132. The mapping code 136 may be at least one script, such as a Structured Query Language (SQL) script, but it is not limited to SQL scripts and it can be in other programming languages, such as the one of the fourth generation languages C#, Java, Virtual Basic, Hypertext Preprocessor, or C++. The mapping code 136 defines the manner in which all or some portions of the XML source document 132 are mapped into the target destination selected in step 204.

Following is an exemplary mapping code automatically generated from the XML Column Mapping Definition document of FIG. 5A as a SQL script by the present invention.
Insert into book (bookinfo) values (XMLPARSE (DOCUMENT ‘X’ TRANSFORM ACCORDING to XSLT ‘XSLT source’))

In this example, X is either an XML source document fragment or an entire XML source document and the XSLT source parameter is the source of the selected XSLT code that needs to be applied to the XML data before insertion into the database.

The mapping code generation in the present invention is not limited to a specific RDBMS or programming language. The exemplary SQL script is generated for an IBM® DB2® database and utilizes its XMLPARSE command to access the DB2® parser engine. However, with the user interactive mapping utility 112 of the present invention one can also generate the mapping code 136, from the XML Column Mapping Definition document 134, for other database management systems by adding an XML document style sheet (XSLT) for the specific RDBMS.

The generated XML Column Mapping Definition document 134 contains all user mapping specifications, acquired through user's interaction with the GUI, and includes the programming language information and XPath information. In an XML Column Mapping Definition document 134 the programming language type is defined via a LANGUAGE information tag (SQL, C#, Java, Hypertext Preprocessor, Virtual Basic, C++) to specify the generated mapping code 136 type. It also contains information about the target destination, such as the type tag, which can either be TABLE/VIEW or PROCEDURE; the name tag, such as an XML column name, table name, view name, function, stored procedure name or subcomponent name; the source document type tag, such as FRAGMENT or DOC, indicating whether the entire XML source document or only its fragment needs to be mapped; an ACTION tag indicating INSERT or UPDATE; and XSLT for transforming the XML data. If specified, the XPath is used for navigating and its tag points to an XML source document fragment.

An XML Column Mapping Definition document 134 is defined as an XML-based document that is contained in memory 105, while the user interactive mapping utility 112 is running, or saved in a data storage device 107, 109, 124, 126 file. The file preferably has an extension ‘xcd’ and it may be stored, for later use, in a data storage device which may be in a remote server 120, of a network environment, that is connected to the client 100 computer where the GUI is running. The fully qualified names of all available ‘.xcd’ files are preferably listed in an XML-based document which may be named ‘XMLColumnMappingFactories.xml’. The user can assign a unique, user-friendly name to each ‘.xcd’ file in the ‘XMLColumnMappingFactories.xml’ document. When the user interactive mapping utility 112 is started, in step 202, the ‘XMLColumnMappingFactories.xml’ file is read automatically, and all specified ‘.xcd’ files are loaded into memory 105 to be displayed for user's selection.

The structure of an XML Column Mapping Definition document is illustrated in an exemplary XML excerpt shown in FIG. 5B. The mapping code 136 generated by the present invention defines the manner in which data of an entire XML source document 132 or its fragments are mapped, in step 214, into a target destination in step 216. The target destination may be an input parameter of a stored procedure, function, at least one XML column of a target destination database or any other target destination.

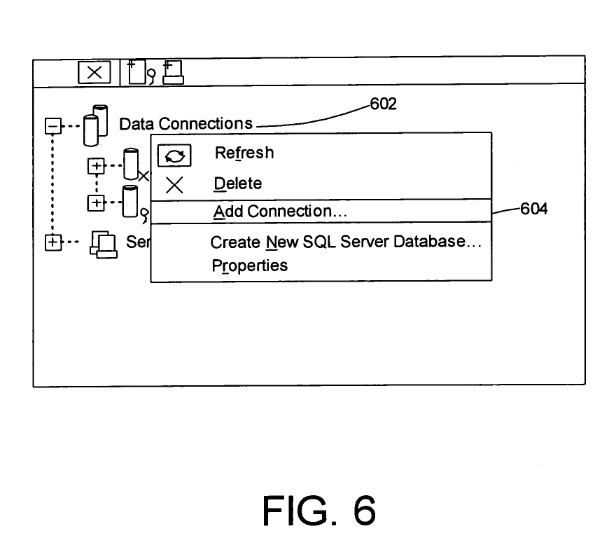

The user interactive mapping utility 112 of the present invention can be implemented in many ways to generate a XML Column Mapping Definition document. One such implementation of the preferred embodiments of the present invention is shown in FIGS. 6-25, and is used in the following examples to illustrate different modes of mapping of XML data by the user interactive mapping utility 112 of the present invention.

In the first example the user interactive mapping utility 112 of the present invention is used for storing data of an XML source document during an update/insert operation on a target destination database column declared as XML format type. The environment is a banking e-commerce site for a global financial transaction tracking system where a large amount of XML data has to be loaded on a regular basis into a table with multiple XML columns. Thus, there is a need for reliable and efficient XML data mapping during XML source document data inserts and updates. A database table named ‘transaction’ has multiple XML columns and an ID column that acts as a primary key. The name of a target destination XML column is ‘TransactionSummary’.

To initiate the automatic mapping of selected XML data during their insert into or update of the XML column ‘TransactionSummary’ a user preferably uses the GUI tool of the present invention which provides a visual interactive menu-driven tool which allows a user to point to a menu entry and select one of the options provided by the GUI for an XML source document, target destination and transformation code. According to the user's interaction with the present invention's GUI, the interactive mapping utility 112 creates an XML Column Mapping Definition document and a mapping code, such as a SQL script. Generated SQL script is sent to the RDBMS to perform transformation of the XML source document data, if specified, and store them in the ‘TransactionSummary’ column.

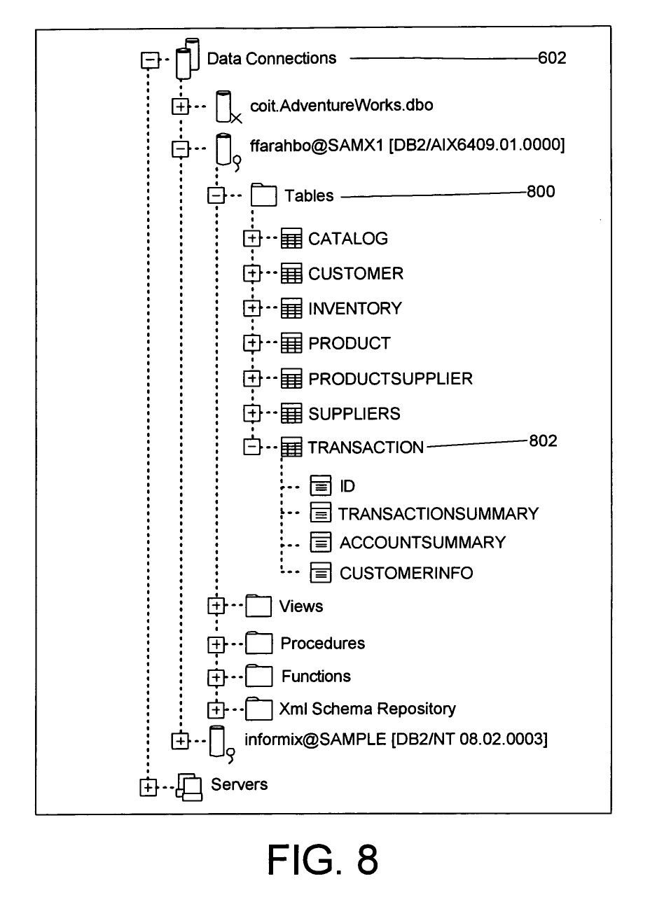

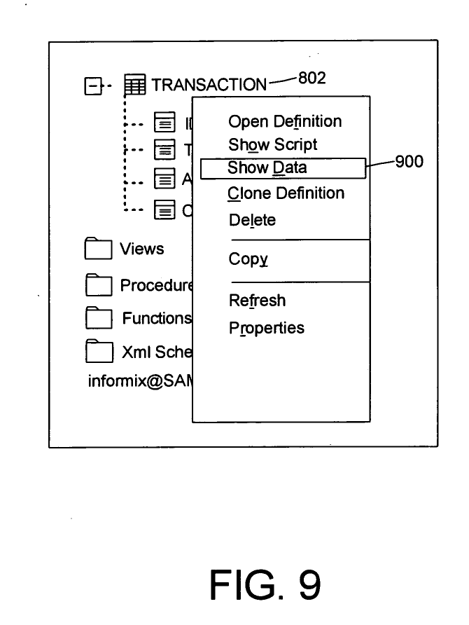

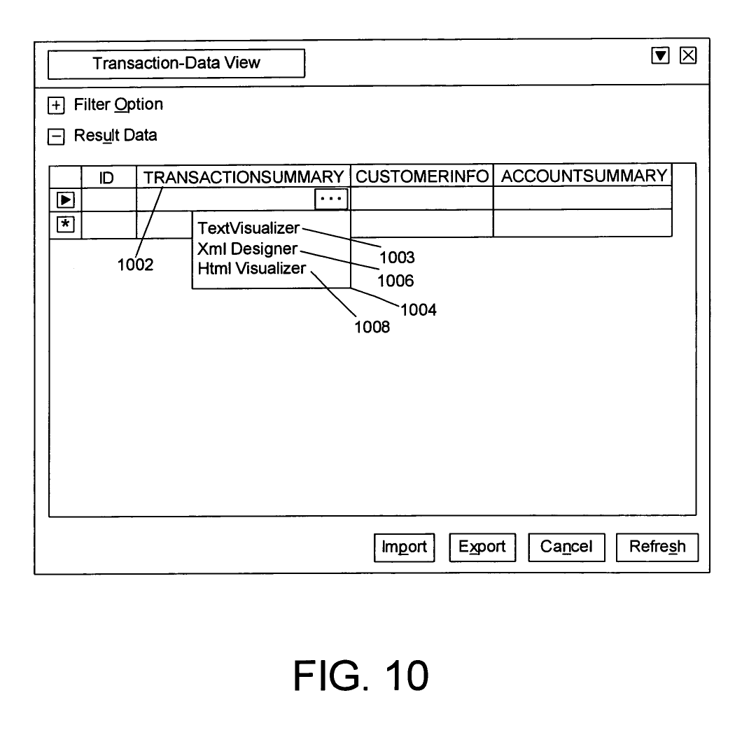

FIGS. 6-24 illustrate the use of an exemplary GUI implementation of the interactive mapping utility 112 of the present invention and show how the mapping and transformation is performed according to the preferred mapping embodiments of the present invention where a database table column is a target destination. FIGS. 6-8 illustrate how a connection to a target destination is formed. From the Tables folder 800 of FIG. 8 the user selects a table named ‘transaction’ 802 from a database Data Connections 602 object list and selects a Show Data menu entry 900 of FIG. 9 which opens the ‘transaction’ table data view window of FIG. 10. An ellipse button appears for each XML column 1002 and a click to an ellipse button displays a tool selection drop-down list 1004 for an XML format type column. The user selects an XML editor tool from the list because this tool allows editing of XML data from the XML source document, their transformation and mapping during insert/update of XML data into an XML column. XML editor tools and their windows are implemented to facilitate interactive visual XML data editing, transformation, mapping and storage, according to the preferred embodiments of the present invention. One of the XML editor tools, named XML Designer tool 1006, is also used for validation of the XML data from the XML source document before storage, as described in the related patent application named “Automated Interactive Visual Mapping Utility For Validation and Storage of XML Data”, incorporated herein by reference.

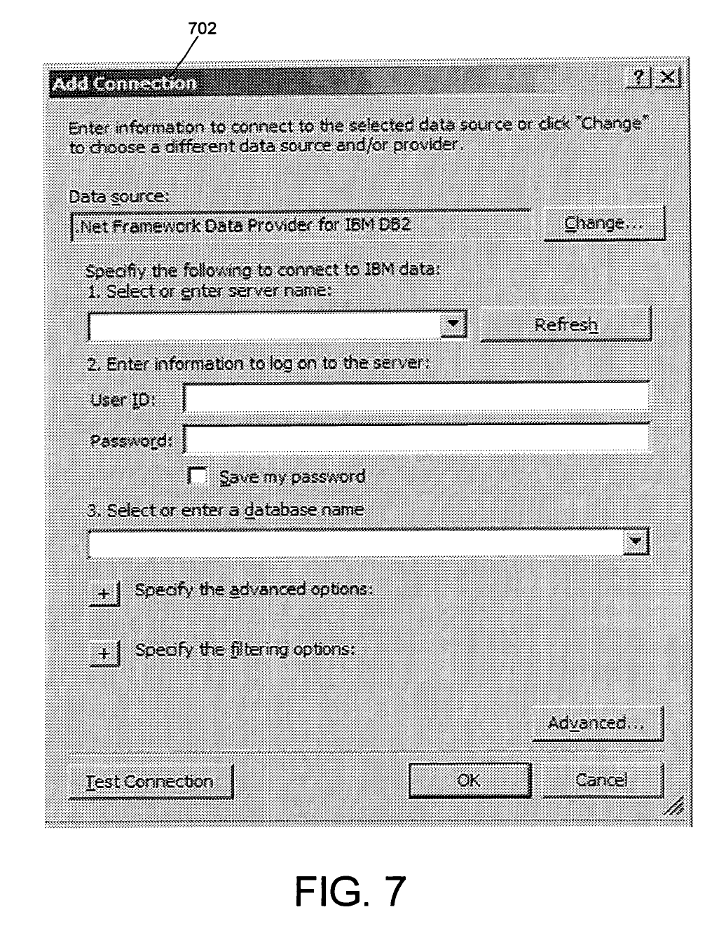

Particularly, the user creates a target destination connection by right-clicking on the Data Connections node 602 of FIG. 6 and by selecting Add Connection entry 604 on the context menu. This action displays an Add Connection dialog box 702 of FIG. 7, used for specifying information for a data connection. The user enters the target destination connection information in the Add Connection dialog box 702, as requested in FIG. 7, and the user interactive mapping utility 112 of the present invention automatically makes the connection.

After a connection to the target destination is made, all database objects, such as tables, views, stored procedures and functions, are displayed in a tree under the connection, as illustrated in FIG. 8, which shows the data connection object list with the Tables folder 800 expanded to allow user's selection of a table and its columns. For this example, the user selects the table named ‘transaction’ 802 from the data source connection object list and then selects a Show Data entry 900 from the menu of FIG. 9 to bring up the Data View window for the table named ‘transaction’, as shown in FIG. 10.

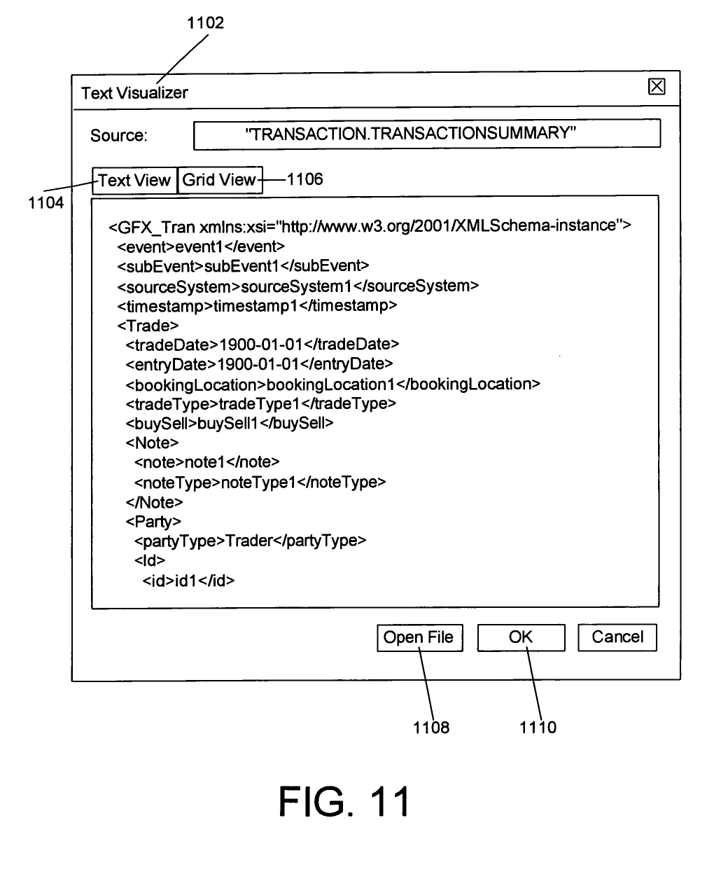

Selection of the Show Data View entry of FIG. 9 opens the Data View for the table ‘transaction’ to display all columns of the table ‘transaction’, as shown in FIG. 10. When the user clicks the ellipse in a cell of the XML column called ‘TransactionSummary’ 1002 it brings up a selection drop-down menu 1004 for the cell with items like Text Visualizer 1003, XML Designer 1006 and Html Visualizer 1008, which the user select accordingly. Selection of the Text Visualizer 1003 tool opens a new window, named Text Visualizer 1003 window and shown in FIG. 11, which is useable for simple XML data entry. Selection of the XML Designer 1006 tool opens a new window, named XML Designer 1006 window and shown in FIG. 15, which is useable for more advanced XML data entry, data transformation and validation.

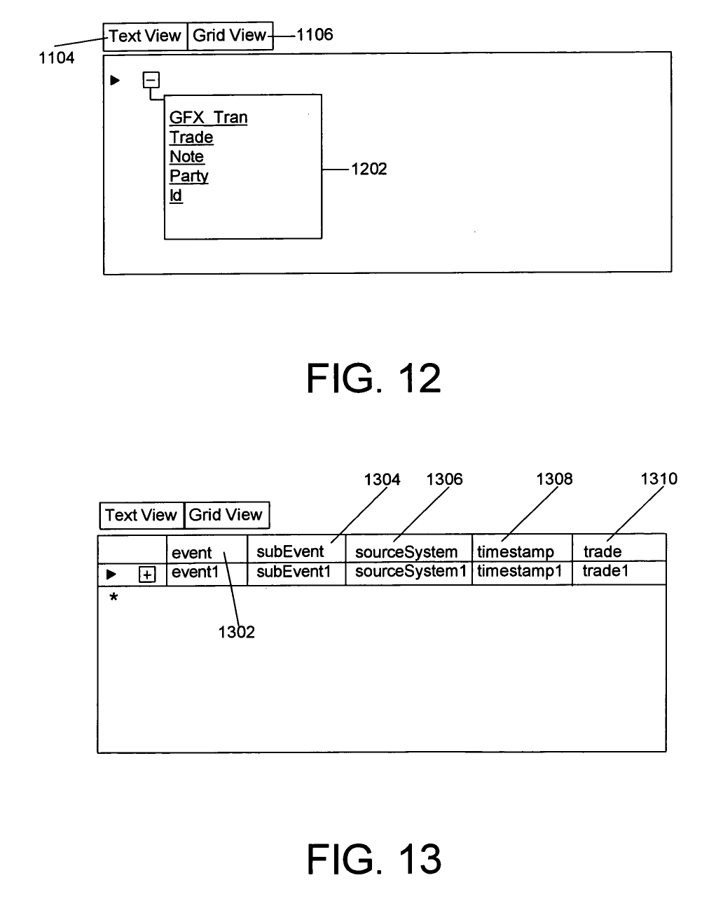

FIG. 11 illustrates the XML Text Visualizer window 1102 which shows XML data and two selection mode buttons, Text View button 1104 and Grid View button 1106. Additionally, Open File button 1108 allows the opening of the XML data source document and OK button 1110 allows storage of the XML data after editing. Text View mode displays XML data in their native format and is used for simple data editing. Grid View mode allows a user to edit and visualize the structure of the XML data source document using a navigational grid 1202, as illustrated in FIG. 12. For example, if a user clicks on the first selection, GFX_Tran, it will expand and allow navigation to its children nodes of FIG. 11, and modification of data value of each such child element, such as event 1302, subevent 1304, sourcesystem 1306, timestamp 1308 and trade 1310, as illustrated in FIG. 13.

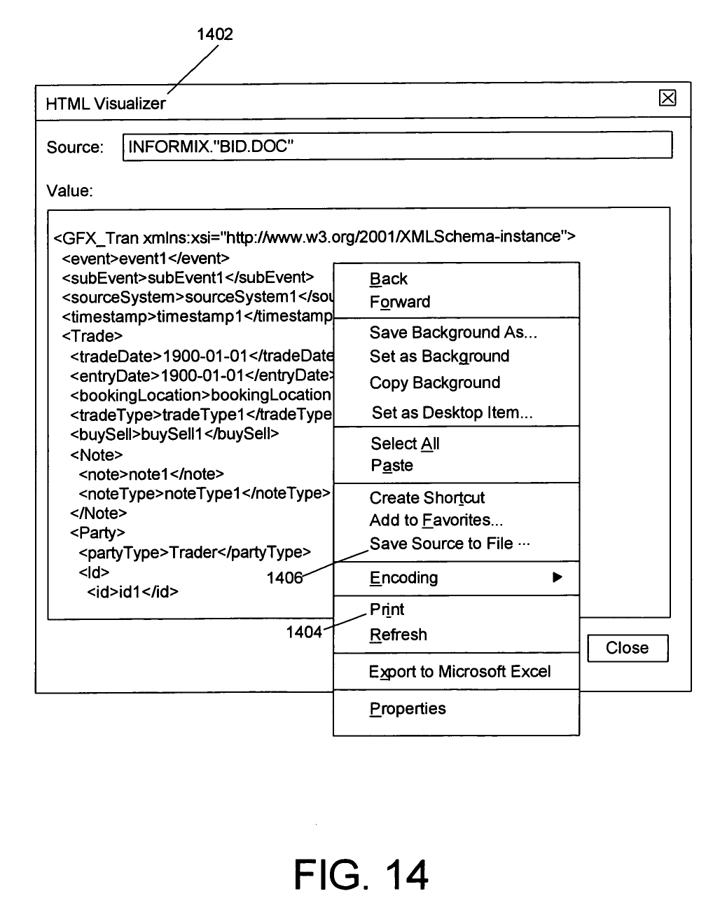

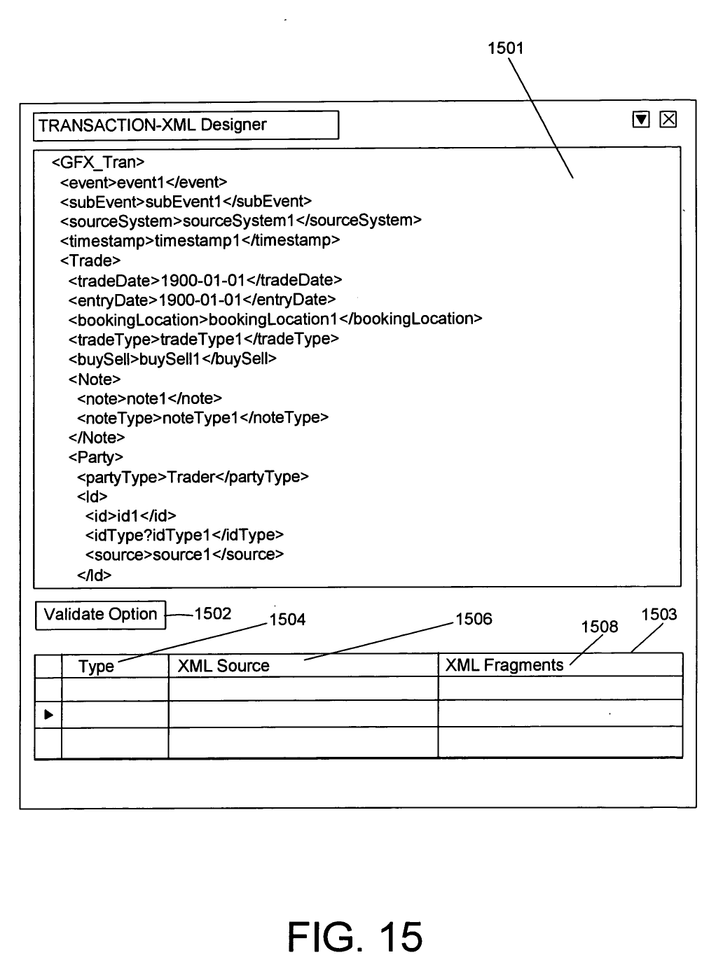

FIG. 14 illustrates the HTML Visualizer window 1402, which launches an embedded browser, and is used to visualize XML data which will be mapped into the target destination XML columns and to start debugging of transformations, if selected, as explained below. The browser context menu has a Print 1404 option which allows a user to print the XML data illustrated in the HTML Visualizer window 1402 and a Save source to File 1406 option which allows saving them into a file.

FIG. 15 illustrates the XML Designer 1006 window which shows XML data 1501 section and a transformation grid 1503. The top panel of the XML Designer window of FIG. 15 shows the XML data of the XML source document in their native format, before they are transformed, validated and stored in the ‘TransationSummary’ 1002 column. A Validate Options button 1502 of the XML Designer window may be used for validations. Transformation grid 1503, shown in the bottom panel of FIG. 15, shows a list of all registered XSLTs, available in the repository, for user's selection. For each XSLT an action type 1504 can be selected from a drop-down list, such as Insert, Update or both, and an XSLT code source 1506 and an XML Fragment 1508.

If a transformation is needed, the user selects one or more XSLT codes from the transformation grid 1503, as shown in the next example. During the insert/update operation, the selected XML data will be stored in the ‘TransactionSummary’ 1002 column. After the user's interaction with the present invention's GUI to select appropriate XML data source document and XML target columns, the user interactive mapping utility of the present invention automatically creates an XML Column Mapping Definition document. When the user tries to update or insert XML data from the XML source document, a mapping code, such as a SQL script, is generated to perform mapping of this XML source document into the ‘TransactionSummary’ 1002 column.

Following exemplary mapping code is automatically generated for an update operation of this example as a SQL script with the following SQL statement.
Update TRANSACTION set TransactionSummary=XMLPARSE (DOCUMENT ‘X’) where ID=?

Following exemplary mapping code is automatically generated for an insert operation of this example as a SQL script with the following SQL statement.
Insert into TRANSACTION (ID, TransactionSummary) values (?, XMLPARSE (DOCUMENT ‘X’))

In the second example the user interactive mapping utility of the present invention is used for transforming and mapping data of an XML source document into a target destination, during an update/insert operation on a column declared as XML format type. The process of selecting a table and its XML type target column and showing it in the XML Designer window is the same as in the first example, shown above in reference to FIGS. 6-15.

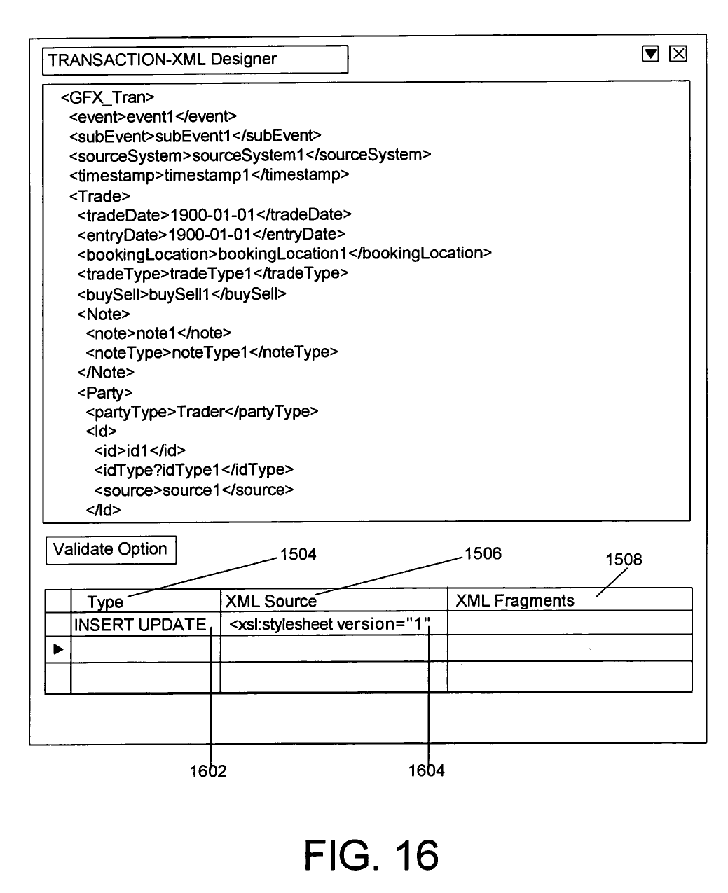

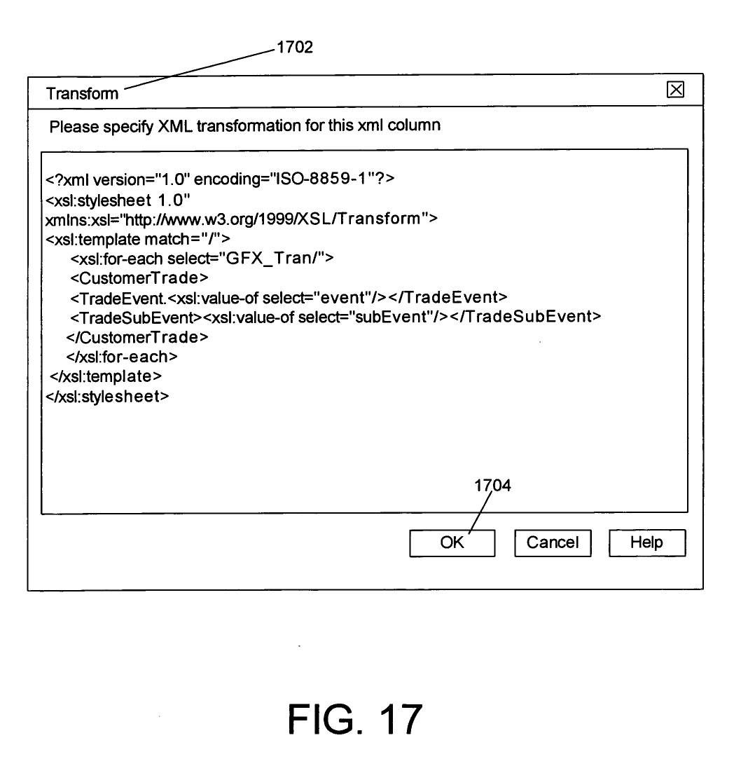

FIG. 16 of the second example shows how a user can select a specific registered XSLT code source from the XSLT source 1506 drop-down list, displayed in the XML Designer window. The user selects both Insert and Update 1602 and the XSLT named ‘xsl:stylesheet version-“1” 1604 to perform the transformation of an XML document before updating or inserting the XML document into the TransactionSummary XML column. XSLT Source 1506 column in transformation grid 1503 contains an ellipse where the user can click to bring up a Transform dialog 1702 of FIG. 17 to edit the data. Click on an OK button 1704 will start the transformation with the selected XSLT source.

The user's interaction with the present invention's GUI creates an XML Column Mapping Definition document. When the user tries to update or insert XML data from the XML source document a SQL script is generated to perform transformation and mapping of this XML source document, based upon the selected XSLT for each Update and/or Insert operation.

Following exemplary transformation and mapping code is automatically generated for an update operation of this example as a SQL script with the following SQL statement.
Update TRANSACTION set TransactionSummary=XMLPARSE (DOCUMENT ‘X’ TRANSFORM ACCORDING TO XSLT ‘XSLT source’) where ID=?

Following exemplary transformation and mapping code is automatically generated for an insert operation of this example as a SQL script with the following SQL statement.
Insert into TRANSACTION (ID, TransactionSummary) values (?, XMLPARSE(DOCUMENT ‘X’ TRANSFORM ACCORDING TO XSLT ‘XSLT source’))

In the third example the present invention is used for mapping and storing a fragment of the XML source document during an update/insert operation on a database column declared as XML format type. The process of selecting a table and XML columns and the display in the XML Designer window is the same as in previous examples, shown above in reference to FIGS. 6-15. However, in this example the user defines a finer mode of mapping, mapping in an XML fragment mode, and only the selected fragment will be mapped. With the present invention's GUI, the user can draw a box around each XML source document fragment and does not have to know where the XML fragment starts and ends because the mapping is performed via XPath. The user interactive mapping utility of the present invention automatically calculates the XML fragment's end tag, draws an XML fragment block and creates an XPath and a default label for the XML fragment. The user can modify the XML fragment label at any time. For each fragment an XPath is created dynamically.

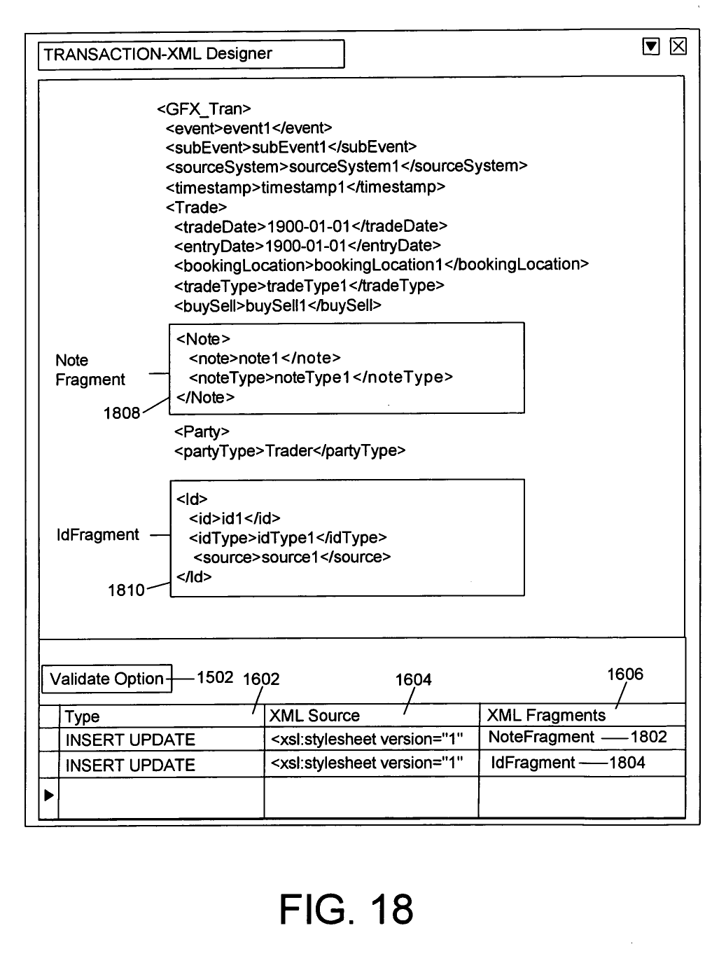

The user selects the fragments' labels, as shown in FIG. 18, from the XML Fragments column 1606, located at the bottom panel of the XML Designer window. FIG. 18 illustrates two fragments' labels, NoteFragment 1802 and IdFragment 1804, that have been selected by the user from the XML Fragments 1606 drop-down list. User's interaction with the present invention's GUI creates an XML Column Mapping Definition document. When the user tries to update or insert XML selected data fragments NoteFragment 1808 and IdFragment 1806, shown in their native format and subject to editing via the XML Designer window, a SQL script is generated to perform mapping of these XML source document fragments.

In this example two update and two insert operations, on two XML fragments, are generated against the same table and XML column. Since there are multiple XML fragments selected, each XML fragment requires a separate update and insert operation. Next, the user interactive mapping utility of the present invention automatically generates a mapping code as SQL scripts shown below, created for mapping during the update and insert operations of fragments X and X2, selected with the GUI, where X is an XML source document fragment identified by NoteFragment and X2 is an XML source document fragment identified by IdFragment.

Following exemplary mapping code is automatically generated for an update operation of this example as a SQL script with the following SQL statements.
Update TRANSACTION set TransactionSummary=XMLPARSE (DOCUMENT ‘X’ TRANSFORM ACCORDING TO XSLT ‘XSLT source for NoteFragment’) where ID=?
Update TRANSACTION set TransactionSummary=XMLPARSE (DOCUMENT ‘X2’ TRANSFORM ACCORDING TO XSLT ‘XSLT source for IdFragment’) where ID=?

Following exemplary mapping code is automatically generated for an insert operation of this example as a SQL script with the following SQL statements.
Insert into TRANSACTION (ID, TransactionSummary) values (?, XMLPARSE (DOCUMENT ‘X’ TRANSFORM ACCORDING TO XSLT ‘XSLT source for NoteFragment’))

Insert into TRANSACTION (ID, TransactionSummary) values (?, XMLPARSE (DOCUMENT ‘X2’ TRANSFORM ACCORDING TO XSLT‘XSLT source for IdFragment’))

In the present invention the XML columns of the target destination may belong to the same or different database tables residing in one or more databases of a heterogeneous RDBMS environment, possibly with physically distributed and disparate DBMSes residing on different hardware systems and possibly storing data in different formats. The target destination of the XML data may also be a web service call, a standalone application call, a stored procedure's input or input/output parameter of XML type, etc.

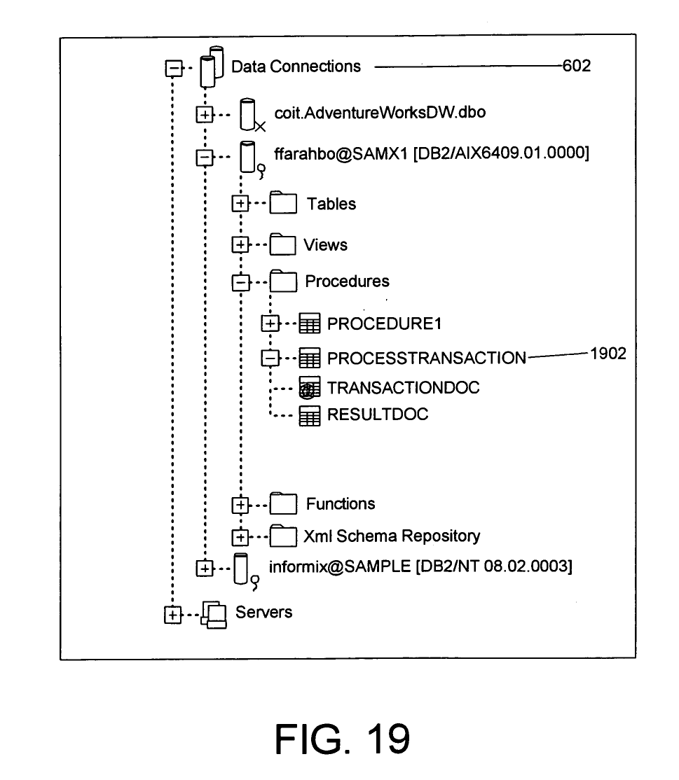

FIGS. 19-24 illustrate two examples for mapping a stored procedure's input parameter. FIGS. 19-24 correspond to FIGS. 6-18 but here the target destination is a stored procedure's input parameter, according to the preferred stored procedure mapping embodiments of the present invention. FIG. 19 illustrates mapping of XML data into an input or input/output parameter of a stored procedure, where the mapping of the parameter will be performed when the procedure is called for execution. This example is also applicable to an input parameter of a function.

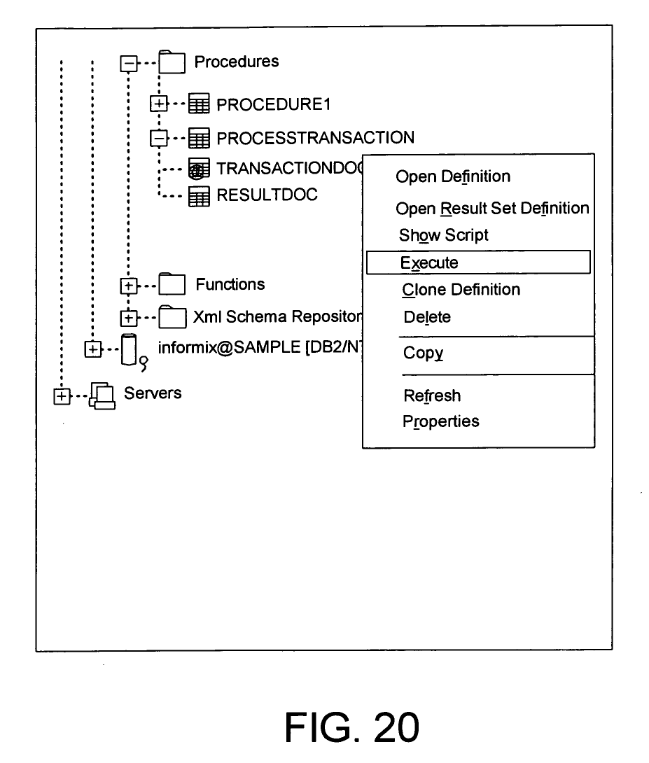

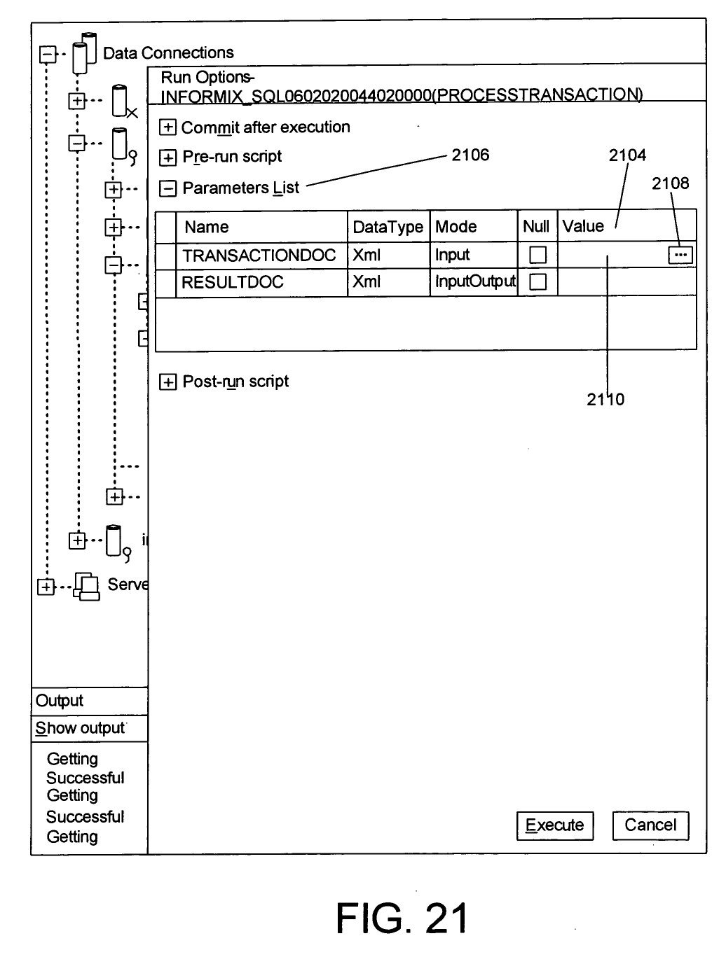

In the fourth example the present invention is not used for mapping a table type object but for mapping of an input or input/output parameter of a stored procedure, declared as XML format type, performed during execution of the stored procedure. The user selects a stored procedure PROCESSTRANSACTION 1902 from the Data Connections 602 object list, as shown in FIG. 19. This stored procedure has two parameters, TRANSACTIONDOC and RESULTDOC, and TRANSACTIONDOC parameter is an input parameter of XML format type to be mapped when a user selects the PROCESSTRANSACTION procedure and selects Execute 2002 from the context menu of FIG. 20. Once the Execute 2002 selection is made, a Run Option dialog box 2102 pops up allowing the user to enter values for input parameters TRANSACTIONDOC and RESULTDOC in a Value column 2104 of a Parameter List grid 2106, as shown in FIG. 21.

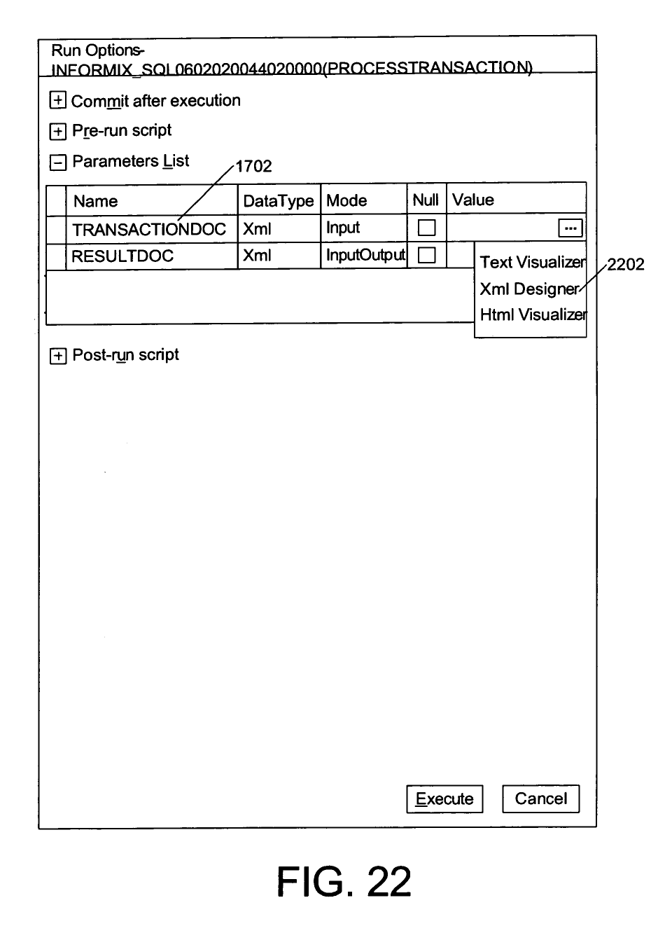

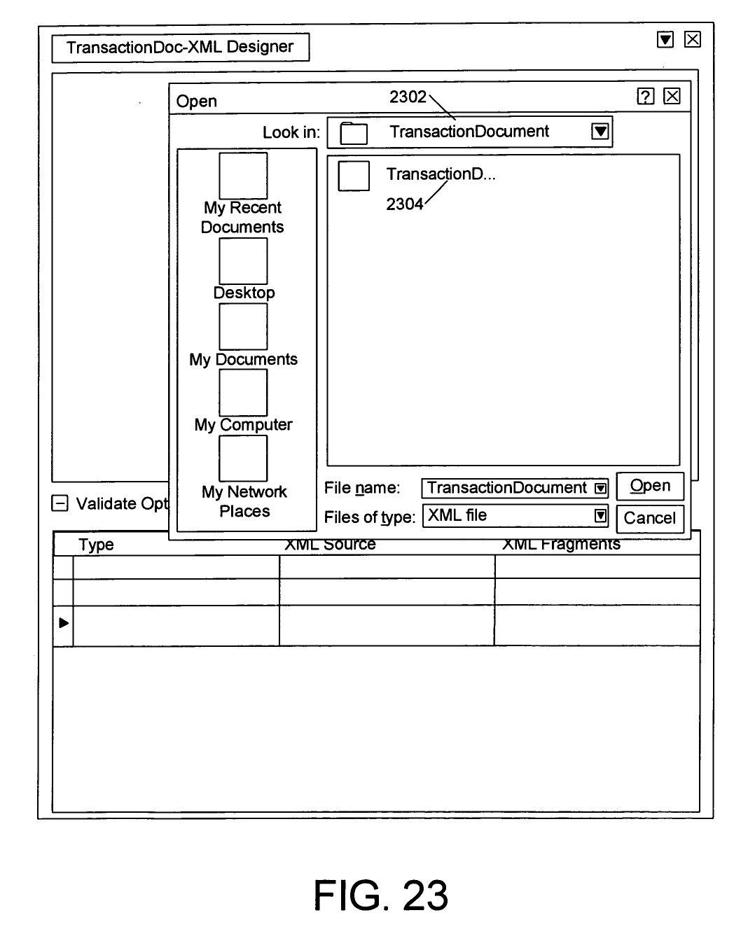

An ellipse button 2108 appears for each XML format type parameter object in the Value column 2104. When the user clicks on it in the Value column of TRANSACTIONDOC parameter 2110, a drop-down list for this column presents the XML Designer item 2202, which the user selects to perform the mapping, as shown in FIG. 22. After the user selects the XML Designer from the drop-down list, the XML Designer opens a system file TransactionDocument directory 2302, as shown in FIG. 23. This allows the user to select an XML data source document 2304 file from TransactionDocument directory 2302 to be mapped with the target destination which is the selected input parameter of the stored procedure, as shown in FIG. 23.

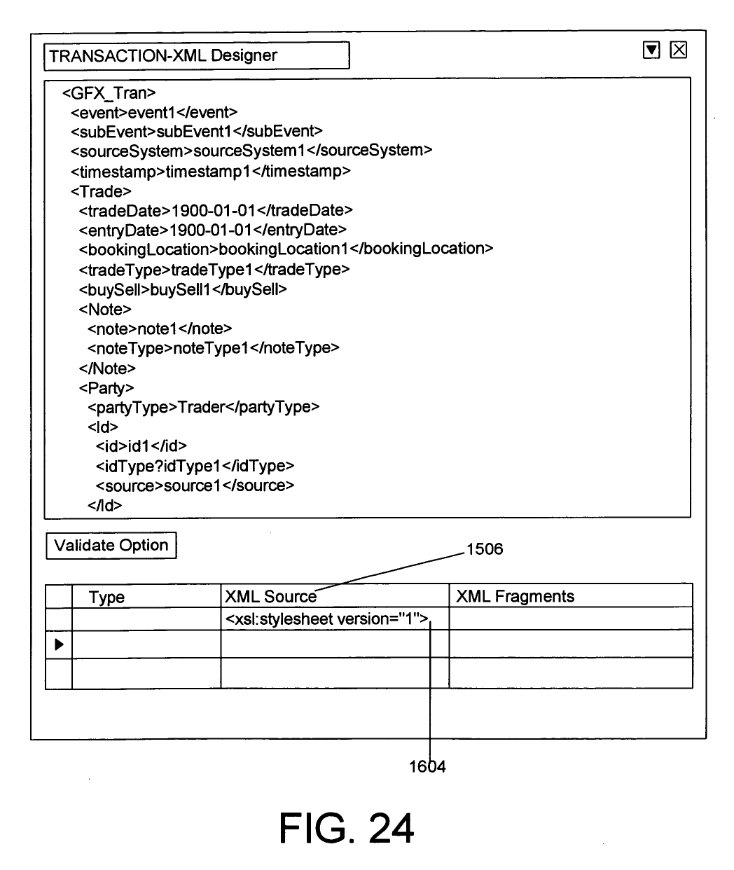

Once the XML data source document 2304 is selected from the system file directory 2302, the top panel 2402 of the XML Designer window shows the selected XML document in its native format, as shown in FIG. 24. The bottom panel of the XML Designer, named the Transaction Grid 1503 section, presents a list of all XSLT sources 1506 available in the repository. If a transformation is required, a user selects an XSLT source named ‘xsl:stylesheet version-“1” 1604 to perform the transformation of an XML document before updating or inserting the selected XML document into the selected input parameter of the stored procedure. The user's interactions with the invention's GUI tool create an XML Mapping Definition document. When the user tries to execute the selected stored procedure, a mapping code is generated to perform transformation of the selected XML data and its assignment to the input parameter.

Following exemplary transformation and mapping code is automatically generated for an execute stored procedure call operation of this example as a SQL script with the following SQL statement.
Call PROCESSTRANSACTION (XMLPARSE (DOCUMENT ‘X’ TRANSFORM ACCORDING TO XSLT ‘XSLT source’), null)

In the fifth example the present invention is used for mapping two fragments of the XML source document during execution of a stored procedure. An input or input/output parameter of a stored procedure, declared as XML format type, is dynamically mapped against multiple XML fragments from an XML source document during the execution of the stored procedure. Since there are two XML fragments, each XML fragment requires a separate call stored procedure statement.

The process of selecting an XML input parameter in the XML Designer window is the same as in the previous example, shown above in reference to FIGS. 15-24. However, in this example the user defines a finer mode of mapping, mapping in an XML fragment mode, and only the selected fragment will be mapped. With the present invention's GUI tool, the user can draw a box around each XML source document fragment, as explained in the third example, and does not have to know where the XML fragment starts and ends because the mapping is performed via XPath. The user interactive mapping utility of the present invention automatically calculates the XML fragment's end tag, draws an XML fragment block and creates an XPath and a default label for the XML fragment. The user can modify the XML fragment label at any time. For each fragment an XPath is created dynamically.

User's interaction with the present invention's GUI creates an XML Mapping Definition document. When the user tries to execute the stored procedure a SQL script is generated to perform mapping of these XML source document fragments. In this example two call statements are generated against the same stored procedure. Since there are two XML fragments each XML fragment requires a separate call statement. Next, the user interactive mapping utility of the present invention automatically generates a mapping code as a SQL script shown below, created for mapping of the selected input parameter's fragments X and X2, selected with the GUI.

Following exemplary mapping code is automatically generated for an execute stored procedure call operation of this example as a SQL script with the following SQL statements.
Call PROCESSTRANSACTION (XMLPARSE(DOCUMENT ‘X’ TRANSFORM ACCORDING TO XSLT ‘XSLT source for NoteFragment’),null)
Call PROCESSTRANSACTION (XMLPARSE (DOCUMENT ‘X2’ TRANSFORM ACCORDING TO XSLT ‘XSLT source for IdFragment’),null)

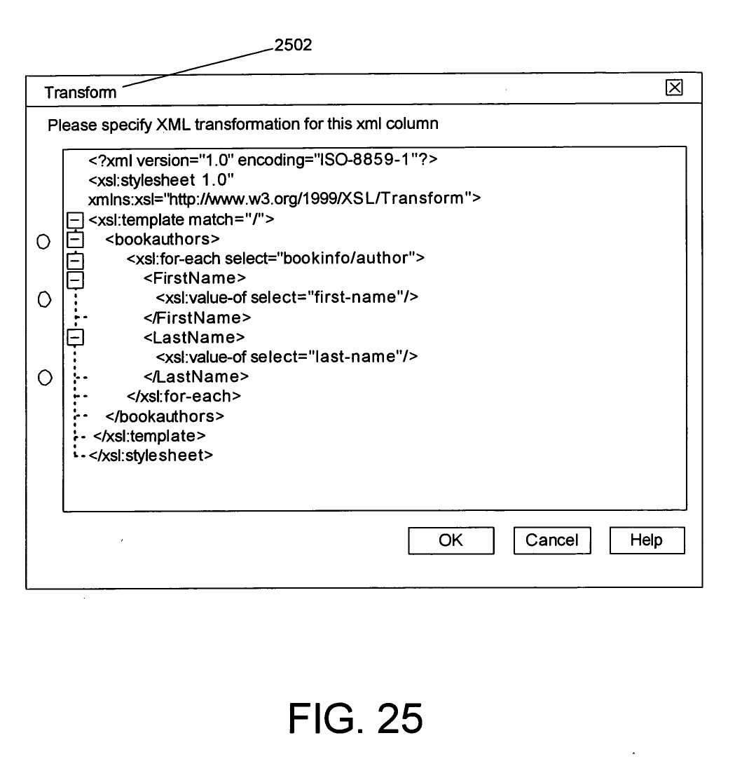

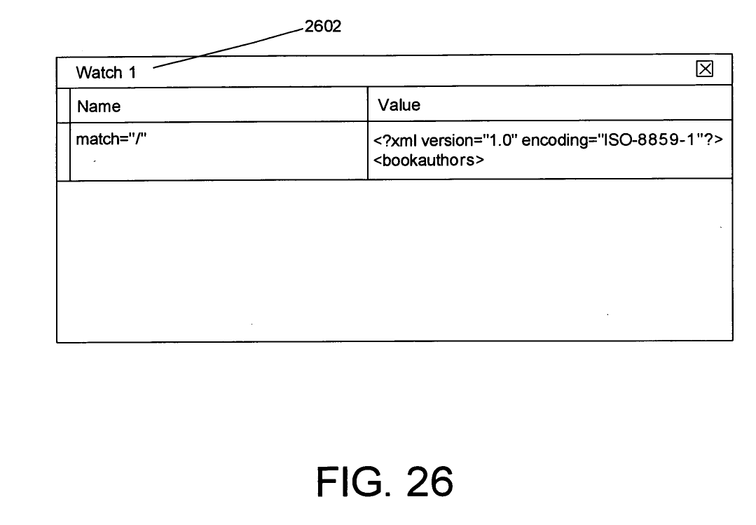

As noted above, the HTML Visualizer of the present invention can be used for debugging of the transformation process, as illustrated in FIGS. 25-26. Sometimes the resulting XML document is not transformed correctly by the XSLT code, based on the user defined rules. For example, a user may want to add trade amounts for a particular date and the addition rule is already defined in the XSLT code. However, when the selected XML column's XML source document is transformed it shows trade sum as zero. In this case the user can utilize the HTML Visualizer of the present invention to perform debugging of the XSLT code and data and perform corrections before committing the update or insert operation. Using a Transform dialog 2502 of FIG. 25 the user can put breakpoints in the XSLT code. The process of launching the Transform dialog 2502 and how it is being used has been already explained in the second example. Setting breakpoints for the XSLT code in the Transform dialog 2502 can be done by selecting a line containing a breakpoint. When all desired breakpoints in the XSLT code have been selected, the user starts the HTML Visualizer for a target destination XML column or a stored procedure XML input parameter, as explained in previous examples. If there are any breakpoints defined in the XSLT code, the cursor goes to the first breakpoint and highlights that line. User can then step through the XSLT code lines while the partial transformation output for that breakpoint is displayed in a watch window 2602 of FIG. 26 and perform desired corrections.

As shown above, the present invention allows the user to visually select and to dynamically map to a target destination an entire XML documents or their fragments and to automatically transform and store the XML data without creating or changing any program code or writing any database commands or code-based applications. Thus, the user can concentrate on the XML source document content rather than on the mapping procedure. Because the complex manipulation of XML documents is removed from the user, with the help of the user interactive mapping utility of the present invention, the transformation and mapping process is much easier and accessible to a larger group of users than the conventional tools. With the user interactive mapping utility of the present invention the transformation and mapping process itself is hidden from the users and does not require any human intervention, thus eliminating errors. As an XML document evolves, there is no need to change code or logic because the mapping definitions and mapping code are created automatically and stored for future use. Moreover, because the use of the user interactive mapping utility GUI is self-explanatory, no learning is required for novice users and the users do not have to be savvy and know how to write code and rules' syntax.

The user interactive mapping utility of the present invention can be used by application developers but is especially beneficial as a human interface tool for data administrators for I/O entry of XML data. The preferred embodiments of the present invention have been implemented in the DB2® for z/OS® V9, in the DB2® MS Visual Studio NET® Extender. They are usable in repository systems that may contain one or more relational database systems and are especially applicable for networks and distributed database systems.

The foregoing description of the preferred embodiments of the present invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for automatic mapping of Extensible Markup Language (XML) data through an interactive visual mapping tool, before storing the XML data into a target destination, comprising:
using an interactive visual mapping tool having a graphic user interface (GUI) to obtain automatic mapping of an XML source document and the target destination.

2. The method according to claim 1, wherein the mapping step further comprises a transformation of the XML data performed with an Extensible Stylesheet Language Transformation (XSLT).

3. The method according to claim 2, wherein the XML data transformation is debugged.

4. The method according to claim 1, wherein the mapping step further comprises a text editing of the XML data and the GUI displays the XML data in native format.

5. The method according to claim 1, wherein the GUI automatically generates an XML mapping definition document and a mapping code.

6. The method according to claim 5, wherein the generated XML mapping definition document comprises a programming language of the mapping code, a type and name of the XML source document and a location of the target destination.

7. The method according to claim 6, wherein the mapping code programming language is selected from the group consisting of a Structured Query Language (SQL) script, C# code, Java code, Virtual Basic code, Hypertext Preprocessor code, and C++ code.

8. The method according to claim 1, wherein the GUI is menu-driven.

9. The method according to claim 1, further comprising:
a user selects an XML fragment by drawing a box around it, and
the GUI automatically dissects the XML data into XML fragments, calculates the XML fragment's end tag, draws an XML fragment block around the selected XML fragment and creates the XML fragment's label and path.

10. The method according to claim 1, wherein:
the XML source document is stored in the target destination selected from the group consisting of an XML column of a database table, a web service call, a standalone application call, a function's input parameter of XML type, a stored procedure's input or input/output parameter of XML type, and a heterogeneous RDBMS environment.

11. A system for automatic mapping of Extensible Markup Language (XML) data through interactive visual mapping, before storing the XML data into a target destination, comprising:
an interactive visual mapping tool having a graphic user interface (GUI) to obtain automatic mapping of an XML source document and the target destination.

12. The system according to claim 11, wherein the interactive visual mapping tool further comprises an Extensible Stylesheet Language Transformation (XSLT) for the XML data transformation.

13. The system according to claim 12, wherein the interactive visual mapping tool further comprises an XSLT debugger.

14. The system according to claim 11, wherein the interactive visual mapping tool further comprises a text editor of the XML data and the GUI displays the XML data in native format.

15. The system according to claim 11, wherein the GUI automatically generates an XML mapping definition document and a mapping code.

16. The system according to claim 15, wherein the generated XML mapping definition document comprises a programming language of the mapping code, a type and name of the XML source document and a location of the target destination.

17. The system according to claim 16, wherein the mapping code programming language is selected from the group consisting of a Structured Query Language (SQL) script, C# code, Java code, Virtual Basic code, Hypertext Preprocessor code, and C++ code.

18. The system according to claim 11, wherein the GUI is menu-driven.

19. The system according to claim 11, further comprising:
a user selects an XML fragment by drawing a box around it, and
the GUI automatically dissects the XML data into XML fragments, calculates the XML fragment's end tag, draws an XML fragment block around the selected XML fragment and creates the XML fragment's label and path.

20. The system according to claim 11, wherein:
the XML source document is stored in the target destination selected from the group consisting of an XML column of a database table, a web service call, a standalone application call, a function's input parameter of XML type, a stored procedure's input or input/output parameter of XML type, and a heterogeneous RDBMS environment.

21. A computer program product comprising a computer useable medium having a computer readable program for automatic mapping of Extensible Markup Language (XML) data through an interactive visual mapping tool, before storing the XML data into a target destination, wherein the computer readable program when executed on a computer causes the computer to:
execute an interactive visual mapping tool having a graphic user interface (GUI) to obtain automatic mapping of an XML source document and the target destination, according to a user's interactions with the GUI.

22. The computer program product according to claim 21, wherein the mapping step further comprises a transformation of the XML data performed with an Extensible Stylesheet Language Transformation (XSLT).

23. The computer program product according to claim 22, wherein the XML data transformation is debugged.

24. The computer program product according to claim 21, wherein the mapping step further comprises a text editing of the XML data and the GUI displays the XML data in native format.

25. The computer program product according to claim 21, wherein the GUI automatically generates an XML mapping definition document and a mapping code.

26. The computer program product according to claim 25, wherein the generated XML mapping definition document comprises a programming language of the mapping code, a type and name of the XML source document and a location of the target destination.

27. The computer program product according to claim 26, wherein the mapping code programming language is selected from the group consisting of a Structured Query Language (SQL) script, C# code, Java code, Virtual Basic code, Hypertext Preprocessor code, and C++ code.

28. The computer program product according to claim 21, wherein the GUI is menu-driven.

29. The computer program product according to claim 21, further comprising:
the user selects an XML fragment by drawing a box around it, and
the GUI automatically dissects the XML data into XML fragments, calculates the XML fragment's end tag, draws an XML fragment block around the selected XML fragment and creates the XML fragment's label and path.

30. The computer program product according to claim 21, wherein:
the XML source document is stored in the target destination selected from the group consisting of an XML column of a database table, a web service call, a standalone application call, a function's input parameter of XML type, a stored procedure's input or input/output parameter of XML type, and a heterogeneous RDBMS environment.
